(19) United States
(12) Patent Application Publication
(10) Pub. No.: US 2002/0166943 A1
(43) Pub. Date: Nov. 14, 2002

(54) Tunnel form

(76) Inventor: Fabrice Pertoldi, Willens (FR)

Correspondence Address: Edward J. Kondracki, MILES & STOCKBRIDGE P.C., Suite 500, 1751 Pinnacle Drive, McLean, VA, 22102-3833, US

(21) Appl. No.: 09/853,723

(22) Filed: May 14, 2001

(51) Int. Cl. E02B 1/00; E02D 29/00; B28B 7/20

(52) U.S. Cl. 249/11

(57) ABSTRACT

The invention relates to a tunnel form comprising:

three forming walls (2, 3) forming an inverted U, with each forming wall being constituted by a frame, a forming skin (5) attached to one of the surfaces of the frame and

on one of the two lateral sides of the form, one of two parts of aligning means and joining means, and on the other side, the other part of the aligning means and the joining means,

this tunnel form being characterized in that the base and the lateral edges of the form have a flat bar and the joining and aligning means are attached to the forming walls.

The invention relates to a tunnel form.

Conventionally, a tunnel form is composed of three forming walls that form an inverted U.

This form comprises two vertical forming walls and, at the top, a horizontal forming wall.

Conventionally, the forming surfaces face the outside of the volume defined by said walls.

These forming walls globally form a frame.

A forming skin is attached to one surface of the frame, and stiffeners are attached to the other surface.

In addition to these forming walls, the form comprises supports so that the tunnel form resists the pressure of the concrete that is exerted when the walls are poured.

It also has rolling elements that specifically make it possible to remove the formwork once the poured concrete is hard enough.

These tunnel forms are of predefined length, and generally during construction several tunnel forms are assembled end to end so that the vertical walls and the top slab can be poured together.

In order for the surfaces of the various walls or slabs obtained to have as flat a surface as possible, the forming surfaces of the various tunnels must be aligned.

For this reason, the edges of the forming walls are equipped with devices for aligning and joining the forming surfaces.

In the prior art, these aligning devices are independent from the formwork and partially housed in the frame, and for this reason the frame is formed of U-shaped sections with the concavity facing outward.

Because of this opening of the U, the side can be deformed during a shock.

This arrangement, which should protect the aligning and joining means from shocks, has the above-indicated drawback, which means that the aligning means are frequently displaced.

In essence, the latter are essential elements for obtaining a wall with a surface condition that limits overlaps.

Unfortunately, we have observed that during maneuvers, the concrete has a tendency to accumulate in the concavity of the U-shaped sections, and thus reduces the longevity of the aligning and joining devices.

We also object to the loss of these joining means.

To strip the forms from these tunnels, it is also necessary to add, at the appropriate moment, additional pieces to the base of the formwork in order to allow it to be removed.

The object of the invention is specifically to eliminate the above-mentioned drawbacks, and to this end the subject of the invention is a tunnel form of the above mentioned type comprising:

three forming walls associated with one another by joining means forming an inverted U, with each forming wall being constituted by a frame, a forming skin attached to one of the surfaces of the frame and stiffeners attached to the other surface, and on one of the two lateral sides of the form, one of two parts of the aligning means and the joining means, and on the other side the other part of the aligning means and the joining means, this tunnel form being characterized in that the base and the lateral edges of the form have a flat bar and the joining and aligning means are attached to the forming walls.

### The invention will be better understood with the aid of the following description given as a non-limiting example in reference to the drawing, which schematically represents:

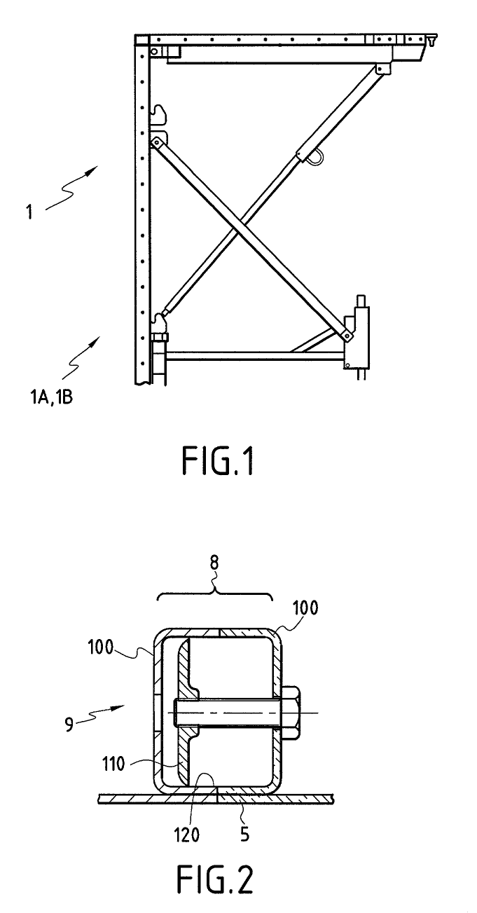

FIGS. 1 and 2: the prior art

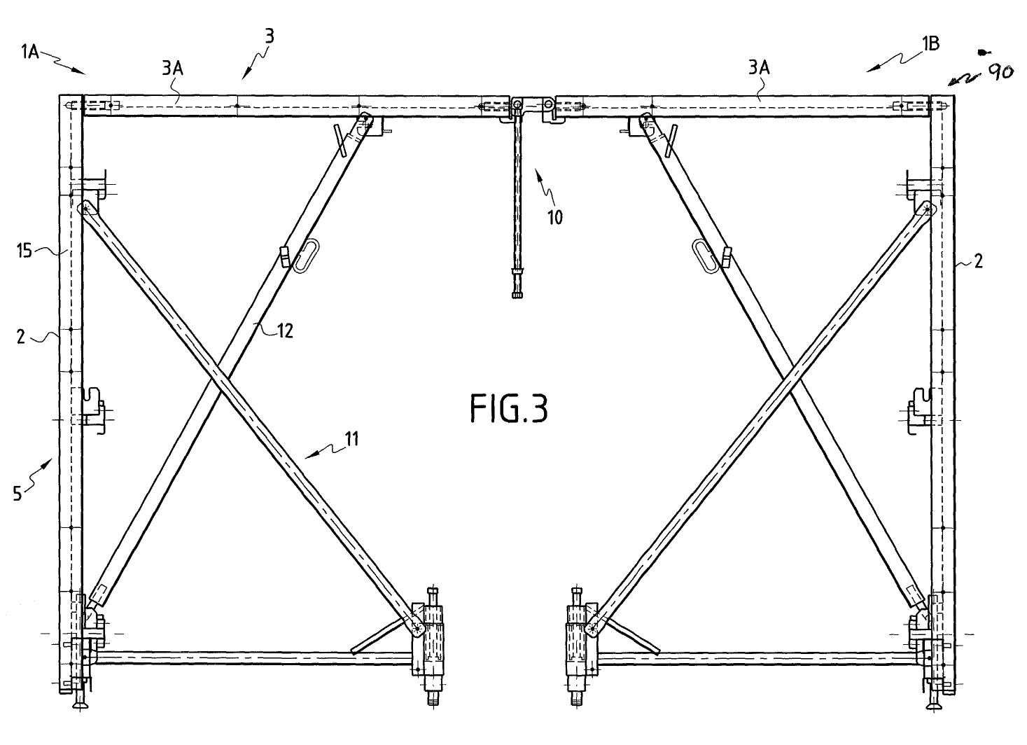

FIG. 3: a tunnel form according to the invention

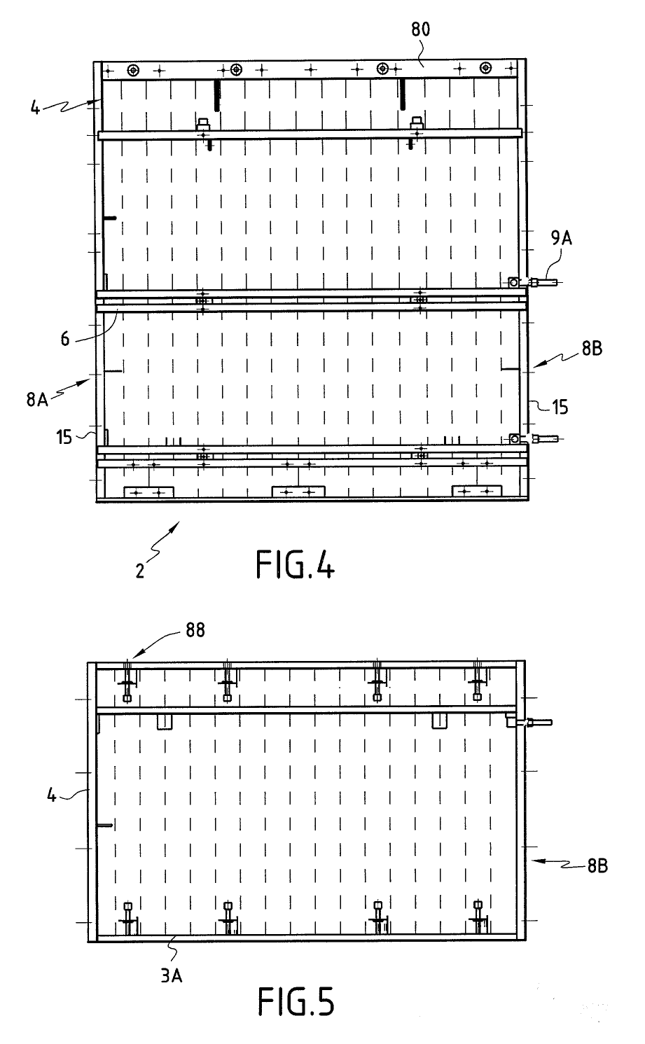

FIG. 4: a vertical formwork panel

FIG. 5: a horizontal formwork panel

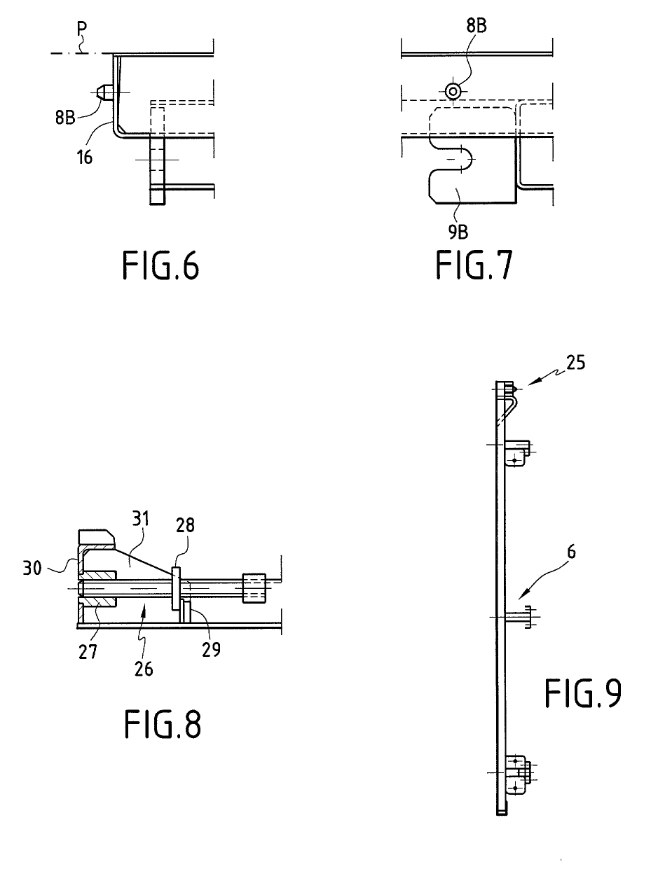

FIGS. 6 through 8: various details of the form according to the invention

FIG. 9: a lateral view of a vertical panel

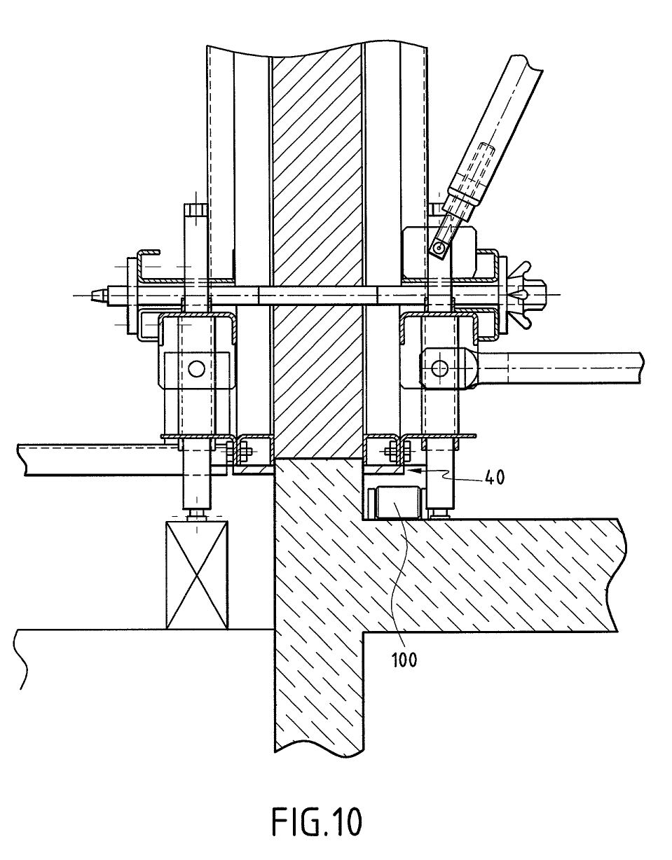

FIG. 10: a view of the end of the base of a tunnel form.

Referring to the drawing, FIG. 1 shows a tunnel form 1 according to the prior art.

This tunnel form is composed of two parts 1A, 1B which, when assembled to one another, form an inverted U.

Conventionally, a tunnel form comprises:

three forming walls 2, 3 associated with one another by joining means 90 forming an inverted U, with each forming wall being constituted by a frame 4, a forming skin 5 attached to one of the surfaces of the frame and stiffeners 6 attached to the other surface, and

on one of the two lateral sides of the form, one of two parts of the aligning means 8 and the joining means 9, and on the other side, the other part of the aligning means and the joining means.

The joining means are understood to be the means 9 for joining the tunnel forms to one another and the means 90 for associating the vertical wall with the horizontal wall.

FIG. 2 shows the aligning and joining means, also according to the prior art.

It shows the outward-facing U-shaped sections 100 that form the frame bearing the forming skin.

The positioning means, which consist in a stop 110 and in the inner surfaces 120 of the U-shaped section, are housed in the cavity formed by the two U-shaped sections disposed facing one another.

A bolt serves as a joining means.

FIG. 3 shows the tunnel form 1 according to the invention.

The latter still comprises three forming walls 2, 3, two vertical walls 2 and a horizontal wall 3, associated with one another by joining means 90.

The horizontal wall is composed of two horizontal panels 3A linked by a mechanism 10 that makes it possible to join and align them.

This mechanism also allows the form to be removed.

This is a mechanism that is available on the market and that will not be described here.

The mechanism is attached to the end of the horizontal wall with joining means 88 identical to those used for the vertical panel/horizontal panel joint.

Other devices 10 also exist.

Supports located on the back of the forming walls bear the loads exerted when the concrete is poured.

There is also a triangulation 11 that is fastened to the vertical panel and a cross-brace 12 that bears the load of the horizontal panel 3A.

These supports form an X.

Rolling 13 and control 14 elements are clearly provided at the base of the tunnel form.

The base and the lateral edges of the form have a flat bar 16, 40 and the joining and aligning means 9, 90 are attached to the forming walls.

According to the invention, the lateral edges 15 of the form are in the form of a flat section 15 and the aligning means are holes 8A produced in this flat section and pins 8B projecting from the outer surface of this flat section.

For example, one of the sides of the tunnel form has only the holes and the other side has only the pins.

The flat section 16 attached to the back of the forming skin is inclined relative to a plane P perpendicular to the forming surface.

The angle thus determined is on the order of 2°.

This flat section 16 is also provided with a lip so as to constitute an L-shaped angle bar.

The joining means 9 therefore consist of a bolt 9A and its nut carried by a shank articulated to the rear surface of the forming wall and a U-shaped support piece 9B that extends in a plane perpendicular to the forming surface.

The length of the shank of the bolt 9A is longer than necessary so that the nut does not have to be completely unscrewed.

In the prior art, as may be seen in FIG. 1, the horizontal panel is attached to the top of the vertical wall.

In the prior art, this attachment is achieved by means of a joining piece attached to the top of the vertical forming wall.

In the novel tunnel form, the horizontal wall is directly attached to the back of the vertical forming wall, and more precisely to the frame of this vertical wall, which for this purpose has one of the two complementary parts of a fastening means.

This fastening or joining means 90 comprises:

a threading 25 presented by the vertical panel and

a bolt 26 carried by the horizontal panel.

The threading is presented by a weld nut.

As may be seen, this nut is mounted on the horizontal panel so as to be captive.

To this end, it is engaged inside a bushing 27 and comprises a stop 28 that cooperates with a fixed stop 29 of the panel, which prevents it from going past the point at which it could possibly disengage from the bushing.

As may be seen, there is also a flat bar 80 on the rear surface of the vertical panel and the surface of the horizontal panel that rests on the latter.

The edge of the panel comprises an angle bar 30 in which holes 27 are provided on the back, which are mounted inside bushings.

Gussets 31 rigidify the assembly, and centering pins are also provided to cooperate with the holes.

As may be seen, the base of the form has a flat bar 40 that makes it possible to roll the form on a roller device. One need only lift the supports of the controls for the form to rest on the rollers so that it can be moved.

This bar 40 is attached by welding to the bottom of the vertical panel, which prevents it from being lost.

As may be seen in FIG. 10, for the removal of the form, the latter rolls on rollers 100.

As indicated above, the back of the forming skin is provided with stiffeners.

At the level of these stiffeners, in the forming skin, passages are provided for the installation of spacers between two forming skins disposed facing one another.

Given the assembly of the horizontal wall to the back of the top part of the frame of the vertical wall, these holes are always the same distance away from the top edge of the form.

The distance between the edge and the position of the holes for the passage of the spacers at the level of the first stiffener from the top, is chosen so as to be like that corresponding to fastening points for external protective brackets, i.e. on the order of 450 millimeters.

1. Tunnel form comprising:
three forming walls (2, 3) associated by joining means forming an inverted U with each forming wall being constituted by a frame (4), a forming skin (5) attached to one of the surfaces of the frame and
on one of the two lateral sides of the form, one of two parts of aligning means (8) and joining means (9), and on the other side the other part of the aligning means and the joining means, this tunnel form being characterized in that the base and the lateral edges of the form have a flat bar (16, 40) and the joining and aligning means (9, 90) are attached to the forming walls.

2. Tunnel form according to claim 1 characterized in that the aligning means are holes (8A) produced in this flat section and pins (8B) projecting from the outer surface of this flat section.

3. Tunnel form according to claim 1 characterized in that one of the sides of the tunnel form has only holes and the other side has only the pins.

4. Tunnel form according to claim 1 characterized in that the flat section (16) attached to the back of the forming skin is inclined relative to a plane perpendicular to the forming surface.

5. Tunnel form according to claim 4 characterized in that the angle is on the order of 2°.

6. Tunnel form according to claim 4 characterized in that flat section (16) is provided with a lip so as to constitute an L-shaped angle bar.

7. Tunnel form according to claim 1 characterized in that the joining means (9) consist in a bolt (9A) and its nut carried by a shank articulated to the rear surface of the forming wall and a U-shaped support piece (9B) that extends in a plane perpendicular to the forming surface.

8. Tunnel form according to claim 1 characterized in that the horizontal wall is directly attached to the back of the vertical forming wall, and more precisely to the frame of this vertical wall, which for this purpose has one of the two complementary parts of a removable fastening means (90).

9. Tunnel form according to claim 7 characterized in that the joining means (90) is:
a threading (25) presented by the vertical panel and
a bolt (26) carried by the horizontal panel.

10. Tunnel form according to claim 9 characterized in that the bolt (26) is engaged inside a bushing (27) and comprises a stop (28) that cooperates with a fixed stop (29) of the panel, which prevents it from going past the point of disengaging from the bushing.

11. Tunnel form according to claim 9 characterized in that threading (25) is presented by a weld nut.

12. Tunnel form according to claim 1 characterized in that the rear surface of the horizontal panel is associated with a mechanism (10) by joining means (88) of the same type as those used to join this horizontal panel with the vertical panel

13. Tunnel form according to claim 1 characterized in that the distance between the top edge of the form and the position of the holes for the passage of the spacers at the level of the first stiffener from the top corresponds to the fastening points of external protective brackets, i.e. on the order of 450 millimeters
